(19) United States
(12) Patent Application Publication
(10) Pub. No.: US 2026/0279655 A1
(43) Pub. Date: Sep. 17, 2026

(54) WIRING CONDUCTOR AND COIL COMPONENT

(71) Applicant: TDK CORPORATION, Tokyo (JP)

(72) Inventors: Mitsuhiro TAKETA, Tokyo (JP); Daisuke SONODA, Tokyo (JP); Takashi OTA, Tokyo (JP); Takuya YOSHIDA, Tokyo (JP); Daiki YAMANE, Tokyo (JP)

(73) Assignee: TDK CORPORATION, Tokyo (JP)

(21) Appl. No.: 19/168,681

(22) PCT Filed: Feb. 26, 2024
(86) PCT No.: PCT/JP2024/006874

§ 371 Date: Sep. 24, 2025

(30) Foreign Application Priority Data
Mar. 30, 2023 (JP) 2023-055471

(51) Int. Cl. H01F 27/28; H01B 1/02; H01F 27/30; H01F 38/14; H02J 50/10

(52) U.S. Cl. CPC H01F 27/2823; H01B 1/02; H01F 27/306; H01F 38/14; H02J 50/10

(57) ABSTRACT

A wiring conductor includes a main body portion. The main body portion includes a first surface and a second surface connecting both edges of the first surface. The second surface is a curved surface, and the aspect ratio that is a ratio of a height of the main body portion from the first surface to a width of the first surface is 0.4 to 1.4.

### TECHNICAL FIELD

The present disclosure relates to a wiring conductor and a coil component.

### BACKGROUND ART

In an electronic device, a coil-shaped wiring conductor may be used.

As such a coil-shaped wiring conductor, for example, Patent Literature 1 below discloses a coil conductor having a mushroom cross section.

### CITATION LIST

### Patent Literature

Patent Literature 1: Japanese Unexamined Patent Publication No. H11-204361

### SUMMARY OF INVENTION

### Technical Problem

Meanwhile, in recent years, wireless earphones have been often used, and an electronic device such as a charger that performs wireless charging has been used to charge the wireless earphones. When such wireless charging is performed, a high-frequency (for example, 13.56 MHz) current flows through the coil-shaped wiring conductor. In such a wiring conductor, when high-frequency current flows, a skin effect, a proximity effect, and an eddy current loss occur, and these deteriorate resistance due to the high-frequency current. The deterioration of the resistance due to the high-frequency current can be expressed by a difference between AC resistance (ACR) and DC resistance (DCR).

However, the wiring conductor described in Patent Literature 1 has the following problems.

That is, the wiring conductor described in Patent Literature 1 has room for improvement in terms of resistance and resistance deterioration when the high-frequency current flows.

The present disclosure has been made in view of the above problem, and an object of the present disclosure is to provide a wiring conductor and a coil component capable of reducing resistance and resistance deterioration even when a high-frequency current flows.

### Solution to Problem

As a result of intensive studies to solve the above problem, the inventors of the present disclosure have found that the above problem can be solved when a main body portion of a wiring conductor has a surface having a width of a predetermined value or more, an aspect ratio that is a ratio of a height of the main body portion to the width of the surface is within a predetermined range, and a surface connecting both edges of the surface is a curved surface that is smoothly curved, and have completed the present disclosure.

That is, one aspect of the present disclosure provides a wiring conductor including a main body portion, in which the main body portion includes a first surface and a second surface connecting both edges of the first surface, the second surface is a curved surface, and an aspect ratio that is a ratio of a height of the main body portion from the first surface to a width of the first surface is 0.4 to 1.4.

According to the wiring conductor of the present disclosure, even when a high-frequency current flows, resistance can be reduced as compared with a wiring conductor having an aspect ratio of less than 0.4. In addition, according to the wiring conductor of the present disclosure, even when the high-frequency current flows, resistance deterioration can be reduced as compared with a wiring conductor having an aspect ratio exceeding 1.4.

The reason why the above effects are obtained is not clear, but it is considered that the above effects are obtained for the following reason. That is, when the high-frequency current flows, the high-frequency current flows on a surface due to the skin effect. At this time, since the aspect ratio of the main body portion is 1.4 or less, the second surface of the main body portion becomes a smoothly curved surface, and concentration of an electric field is less likely to occur. As a result, it is considered that even when the high-frequency current flows, the resistance deterioration can be reduced as compared with the wiring conductor having an aspect ratio exceeding 1.4. In addition, it is considered that when the aspect ratio of the main body portion is 0.4 or more, a cross-sectional area of a portion of the main body portion through which the high-frequency current flows increases as compared with the case where the aspect ratio of the main body portion is less than 0.4, and thus the resistance of the main body portion can be further reduced.

In the wiring conductor, the width of the first surface may be 25 μm or more.

In the wiring conductor, the width of the first surface may be 25 to 60 μm.

The wiring conductor may further include a protrusion provided on the first surface.

In the wiring conductor, the protrusion and the main body portion may include at least one selected from the group consisting of Ag, Au, Zn, Cr, Ni, Sn, Cu, a Cu—Co alloy, a Cu—Fe alloy, a Cu—Pd alloy, a Cu—Sn alloy, a Cu—Zn alloy, a Cu—Fe—Ni alloy, a Cu—Zn—Cd alloy, and a Cu—Zn—Ni alloy.

In the wiring conductor, materials constituting the protrusion and the main body portion may be different from each other.

The wiring conductor may have a coiled shape.

Another aspect of the present disclosure provides a coil component including the wiring conductor having the coiled shape described above and a base material provided at a position facing the wiring conductor.

According to the coil component, even when a high-frequency current flows through the wiring conductor, the resistance and the resistance deterioration can be reduced as compared with a wiring conductor whose aspect ratio is out of the range of 0.4 to 1.4, so that power consumption can be suppressed and the generation of heat can be suppressed.

In the coil component, the base material may be a magnetic body.

The coil component may further include an adhesive layer configured to fix the wiring conductor to the base material.

### Advantageous Effects of Invention

According to the present disclosure, there are provided a wiring conductor and a coil component capable of reducing resistance and deteriorate in resistance even when a high-frequency current flows.

### BRIEF DESCRIPTION OF DRAWINGS

FIG. 1 is a cross-sectional view illustrating an embodiment of a wiring conductor of the present disclosure.

FIG. 2 is a cross-sectional view illustrating the first structure obtained in the first step.

FIG. 3 is a cross-sectional view illustrating the second structure obtained in the second step.

FIG. 4 is a cross-sectional view illustrating the third structure obtained in the third step.

FIG. 5 is a cross-sectional view illustrating the fourth structure obtained in the fourth step.

FIG. 6 is a cross-sectional view illustrating an embodiment of a coil component of the present disclosure.

FIG. 7 is a cross-sectional view illustrating a state before the fourth structure in FIG. 5 is fixed to a fifth structure.

FIG. 8 is a cross-sectional view illustrating a state after the fourth structure in FIG. 5 is fixed to the fifth structure.

### DESCRIPTION OF EMBODIMENTS

Hereinafter, embodiments of the present disclosure will be described in detail.

### <<Wiring Conductor>>

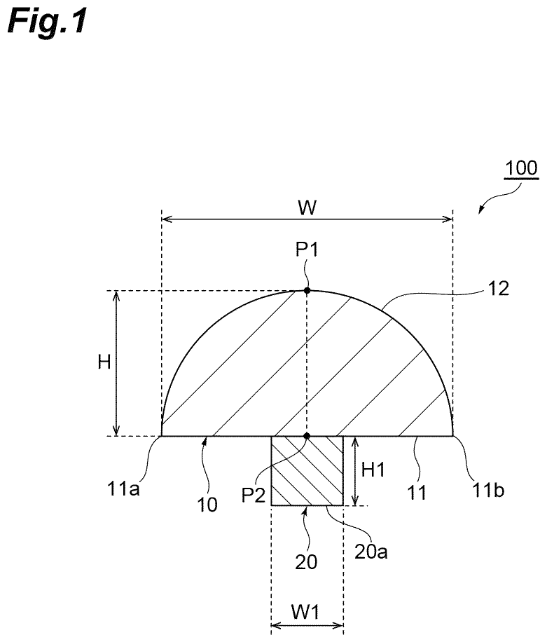

First, an embodiment of a wiring conductor of the present disclosure will be described with reference to the drawings. FIG. 1 is a cross-sectional view illustrating an embodiment of the wiring conductor of the present disclosure.

The wiring conductor 100 illustrated in FIG. 1 includes a main body portion 10 and a protrusion 20. The main body portion 10 includes a first surface 11 and a second surface 12 connecting both edges 11a and 11b of the first surface 11, and the second surface 12 is a curved surface. The protrusion 20 is provided on the first surface 11 of the main body portion 10. In addition, an aspect ratio R1 that is the ratio of a height H of the main body portion 10 from the first surface 11 to the width W of the first surface 11 is 0.4 to 1.4.

According to the wiring conductor 100, even when a high-frequency current flows, resistance can be reduced as compared with a wiring conductor having the aspect ratio R1 of less than 0.4. In addition, according to the wiring conductor 100, even when a high-frequency current flows, resistance deterioration can be reduced as compared with a wiring conductor having the aspect ratio R1 exceeding 1.4.

Furthermore, since the aspect ratio R1 is 0.4 to 1.4 in the main body portion 10, the second surface 12 of the main body portion 10 is a curved surface that is smoothly curved; therefore, even if an external force is applied to the second surface 12, the external force is easily dispersed, and thus chipping is less likely to occur on the second surface 12 of the main body portion 10.

Furthermore, the wiring conductor 100 has the protrusion 20; therefore, when the wiring conductor 100 is fixed to a circuit board by reflow, the protrusion 20 can be easily embedded in solder provided on the circuit board, and the wiring conductor 100 can be stabilized with respect to the circuit board.

Hereinafter, the main body portion 10 and the protrusion 20 will be described in detail.

### <Main Body Portion>

Examples of a material included in the main body portion 10 include Ag, Au, Zn, Cr, Ni, Sn, Cu, a Cu—Co alloy, a Cu—Fe alloy, a Cu—Pd alloy, a Cu—Sn alloy, a Cu—Zn alloy, a Cu—Fe—Ni alloy, a Cu—Zn—Cd alloy, and a Cu—Zn—Ni alloy. These can be used alone or in combination of two or more.

The width W of the first surface 11 of the main body portion 10 refers to the distance between the both edges 11a and 11b of the first surface 11. The width W of the first surface 11 is not particularly limited, but may be 25 μm or more, 10 μm or more, or 5 μm or more.

The width W of the first surface 11 is preferably 60 μm or less. In this case, the wiring conductor 100 can be easily disposed even in a narrow space. The width W of the first surface 11 may be 80 μm or less or 100 μm or less.

The height H of the main body portion 10 refers to the distance between a point P1 of the second surface 12 farthest from the first surface 11 and an intersection point P2 between a perpendicular line drawn from the point P1 and the first surface 11.

The aspect ratio R1 of the main body portion 10 may be 0.4 to 1.4. The aspect ratio R1 of the main body portion 10 may be 0.45 or more, 0.5 or more, or 0.6 or more. In addition, the aspect ratio R1 of the main body portion 10 may be 1.2 or less, 1.0 or less, or 0.8 or less.

Note that for example, as illustrated in FIG. 1, the curved surface may have a shape that is convex to a side opposite to the first surface 11 with respect to a plane passing through the edge 11a and the point P1, and is convex to the side opposite to the first surface 11 with respect to a plane passing through the edge 11b and the point P1.

### <Protrusion>

Examples of a material included in the protrusion 20 include Ag, Au, Zn, Cr, Ni, Sn, Cu, a Cu—Co alloy, a Cu—Fe alloy, a Cu—Pd alloy, a Cu—Sn alloy, a Cu—Zn alloy, a Cu—Fe—Ni alloy, a Cu—Zn—Cd alloy, and a Cu—Zn—Ni alloy. These can be used alone or in combination of two or more.

The material included in the protrusion 20 may be the same as or different from the material included in the main body portion 10.

A width W1 of the protrusion 20 refers to the distance between both edges 11a and 11b of the protrusion 20. The width W1 of the protrusion 20 may be equal to or greater than the width W or less than the width W of the first surface 11 of the main body portion 10.

When the width W1 of the protrusion 20 is smaller than the width W of the first surface 11 of the main body portion 10, a ratio R3 of the width W1 of the protrusion 20 to the width W of the first surface 11 of the main body portion 10 may be, for example, 0.001 or more, and may be 0.003 or more, 0.01 or more, 0.04 or more, 0.05 or more, or 0.06 or more.

The ratio R3 may be less than 1, 0.8 or less, 0.6 or less, 0.4 or less, 0.2 or less, 0.1 or less, or 0.08 or less.

A height H1 of the protrusion 20 refers to a distance from the first surface 11 to an end surface 20a of the protrusion 20. Here, the end surface 20a refers to a surface on the side opposite to the first surface 11 of the main body portion 10.

An aspect ratio R2 that is the ratio of the height H1 of the protrusion 20 to the width W1 of the protrusion 20 is not particularly limited, but is, for example, 0.0005 or more. The aspect ratio R2 of the protrusion 20 may be 0.001 or more, 0.1 or more, or 1 or more. In addition, the aspect ratio R2 of the protrusion 20 may be 10 or less, 5 or less, 3 or less, or 1 or less.

### <Wiring Conductor>

The shape of the wiring conductor 100 is not particularly limited. For example, the shape may be a coiled shape or a linear shape.

When the shape of the wiring conductor 100 is a coiled shape, the wiring conductor 100 is a coil.

### <<Method for Manufacturing Wiring Conductor>>

Next, a method for manufacturing the wiring conductor 100 will be described.

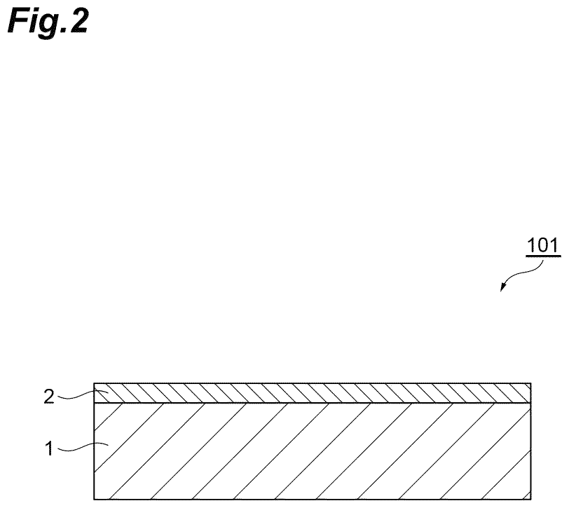

First, after a substrate 1 is prepared, as illustrated in FIG. 2, a conductive layer 2 is formed on the substrate 1 to obtain a first structure 101 (first step).

Examples of the substrate 1 include a glass substrate and a resin substrate. Examples of the resin substrate include a polyethylene terephthalate (PET) film, a polycarbonate (PC) film, a polyethylene naphthalate (PEN) film, a cycloolefin polymer (COP) film, and a polyimide (PI) film.

The thickness of the substrate 1 is not particularly limited, and may be 5 μm or more, 3 μm or more, or 1 μm or more, and may be 1000 μm or less, 3000 μm or less, or 5000 μm or less.

The conductive layer 2 contains a metal. Examples of the metal include Pd, Cu, Ni, Al, Co, Au, Ag, Rh, Pt, In, Fe, and Sn. These metals may be used alone or a combination of two or more kinds.

The thickness of the conductive layer 2 may be 5 nm or more, 10 nm or more, or 30 nm or more, and may be 5 mm or less, 3 mm or less, or 1 mm or less.

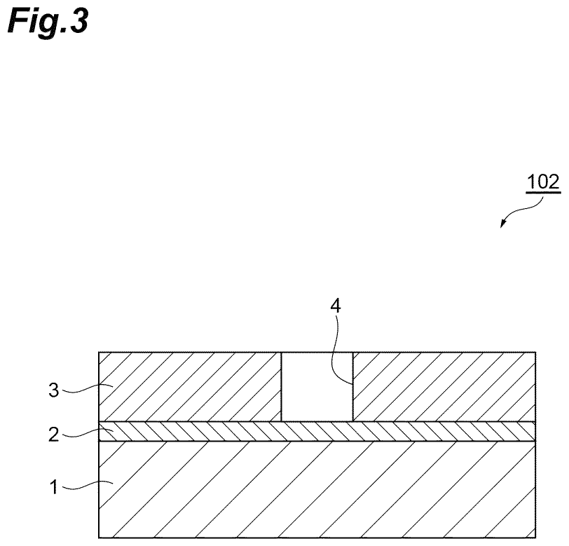

Next, after a resin layer 3 is formed on the conductive layer 2, as illustrated in FIG. 3, a groove pattern 4 is formed in the resin layer 3 to obtain a second structure 102 (second step).

The groove pattern 4 can be formed on a surface of the resin layer 3 on a side opposite to the substrate 1 by an imprinting method. Specifically, a mold having a protrusion is pushed into the resin layer 3, and then the mold is pulled out from the resin layer 3, whereby the groove pattern 4 is formed in the resin layer 3. At this time, the groove pattern 4 is formed so that the conductive layer 2 is exposed, that is, so as to penetrate the resin layer 3.

A resin contained in the resin layer 3 may be a cured product of a curable resin composition (photocurable resin composition or thermosetting resin composition). The curable resin composition contains a curable resin. Examples of the curable resin include an acrylic resin, an amino resin, a cyanate resin, an isocyanate resin, a polyimide resin, an epoxy resin, an oxetane resin, a polyester resin, an allyl resin, a phenolic resin, a benzoxazine resin, a xylene resin, a ketone resin, a furan resin, a COPNA (condensed polycyclic polynuclear aromatic) resin, a silicone resin, a dicyclopentadiene resin, a benzocyclobutene resin, an episulfide resin, an ene-thiol resin, a polyazomethine resin, a polyvinyl benzyl ether compound, acenaphthylene, and an ultraviolet curable resin containing a functional group that causes a polymerization reaction with ultraviolet rays such as an unsaturated double bond, a cyclic ether, and a vinyl ether.

The thickness of the resin layer 3 is appropriately determined according to the height of the protrusion 20. The thickness of the resin layer 3 may be, for example, 200 nm or more, 100 nm or more, or 10 nm or more, and may be 50 μm or less, 10 μm or less, or 5 μm or less.

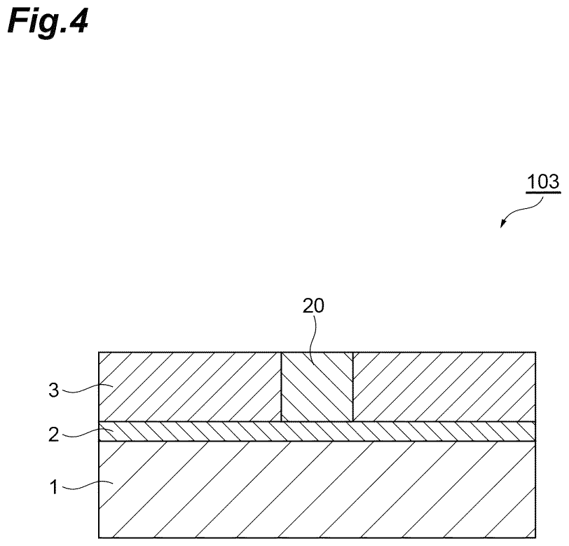

Next, as illustrated in FIG. 4, the protrusions 20 are formed in the groove pattern 4 on the conductive layer 2 by electroless plating to obtain a third structure 103 (third step).

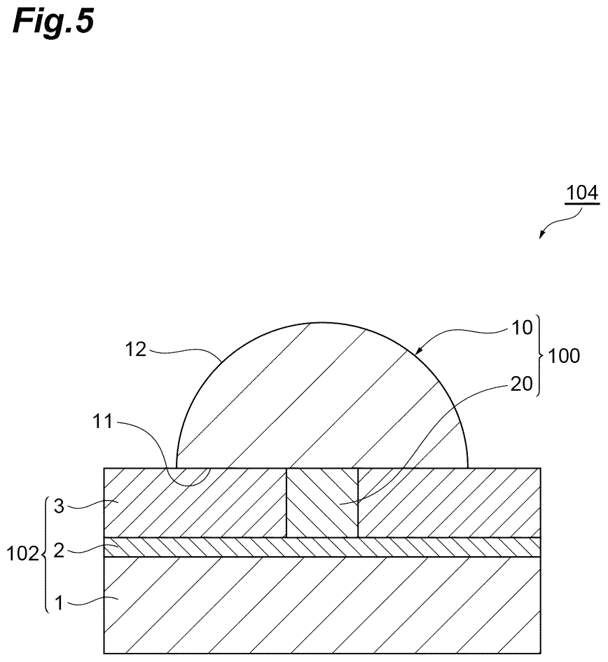

Next, as illustrated in FIG. 5, metal plating is grown on the protrusion 20 by a plating method to form the main body portion 10, thereby obtaining a fourth structure 104 (fourth step).

Furthermore, the second structure 102 is peeled off from the fourth structure 104 as necessary. Thus, the wiring conductor 100 having the main body portion 10 and the protrusion 20 is obtained.

### <<Coil Component>>

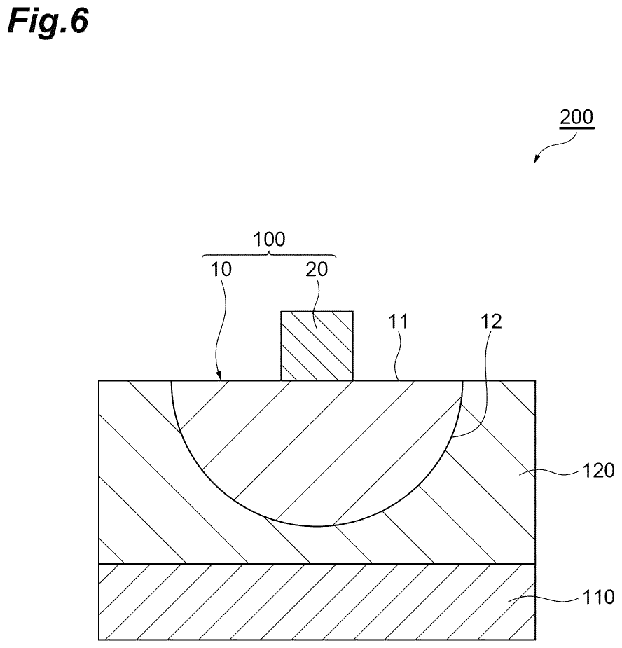

Next, an embodiment of a coil component of the present disclosure will be described with reference to FIG. 6. FIG. 6 is a cross-sectional view illustrating an embodiment of the coil component of the present disclosure.

As illustrated in FIG. 6, the coil component 200 includes the coil-shaped wiring conductor 100, a base material 110 provided at a position facing the wiring conductor 100, and an adhesive layer 120 that fixes the wiring conductor 100 to the base material 110.

According to the coil component 200, even when a high-frequency current flows through the wiring conductor 100, the resistance and the resistance deterioration can be reduced as compared with a wiring conductor whose aspect ratio is out of the range of 0.4 to 1.4, so that power consumption can be suppressed and the generation of heat can be suppressed.

Hereinafter, the wiring conductor 100, the base material 110, and the adhesive layer 120 will be described in detail.

### <Wiring Conductor>

In FIG. 6, in the wiring conductor 100, the second surface 12 that is a curved surface faces the base material 110 side. As a result, a gap is less likely to be formed between the adhesive layer 120 and the second surface 12 of the wiring conductor 100, and the adhesion between the adhesive layer 120 and the second surface 12 of the main body portion 10 is enhanced. In addition, the second surface 12 of the main body portion 10 is a curved surface; therefore, even if excessive stress is applied to the wiring conductor 100, the stress is easily dispersed at an interface between the adhesive layer 120 and the main body portion 10, and the main body portion 10 is less likely to be detached from the adhesive layer 120.

In addition, the width W of the first surface 11 is not particularly limited, but is preferably 60 μm or less. In this case, the inductance of the coil component 200 is improved. The width W of the first surface 11 is more preferably 50 μm or less, and more preferably 40 μm or less from the viewpoint of improving the inductance.

### <Base Material>

The base material 110 is not particularly limited, and can be appropriately selected according to the shape of the wiring conductor 100, or the like. For example, when the wiring conductor 100 has a coiled shape, the base material 110 may be a magnetic body. In this case, the base material 110 forms a magnetic path of a magnetic flux generated by the coil-shaped wiring conductor 100, and the coil component 200 can efficiently transmit a high-frequency magnetic flux.

The magnetic body contains a magnetic metal or a magnetic ceramic. The magnetic body preferably contains a magnetic ceramic. In this case, since the magnetic ceramic has high electric resistivity, eddy current loss in the magnetic body can be reduced.

The magnetic body may be a magnetic metal powder-containing resin in which a magnetic metal or a magnetic ceramic is dispersed in a resin binder.

As the magnetic metal, permalloy (Fe—Ni alloy), superpermalloy (Fe—Ni—Mo alloy), sendust (Fe—Si—Al alloy), an Fe—Si alloy, an Fe—Co alloy, an Fe—Cr alloy, an Fe—Cr—Si alloy, or the like can be used. As the magnetic ceramic, ferrite such as a Ni—Cu—Zn-based ferrite, a Ni—Cu—Zn—Mg-based ferrite, a Cu—Zn-based ferrite, or a Ni—Cu-based ferrite can be used.

As the resin binder, a phenol resin, a urea resin, a melamine resin, polytetrafluoroethylene, polyethylene, polypropylene, polystyrene, polyether sulfone, polyphenylene sulfide, PET (polyethylene terephthalate), PBT (polybutylene terephthalate), polyarylate, a silicone resin, diallyl phthalate, a polyimide resin, or the like can be used. However, when the coil component 200 is connected to a soldered circuit board or the like by reflow, the resin binder is preferably a phenol resin, a urea resin, a melamine resin, polytetrafluoroethylene, a polyimide resin, or the like.

The thickness of the base material 110 is not particularly limited, and may be 20 μm or more, 30 μm or more, 40 μm or more, 50 μm or more, or 60 μm or more.

The thickness of the base material 110 may be 1000 μm or less, 500 μm or less, 300 μm or less, 100 μm or less, or 80 μm or less.

### <Adhesive Layer>

The adhesive layer 120 is a layer that fixes the wiring conductor 100 to the base material 110.

The adhesive layer 120 may be made of a material that can adhere to the base material 110 and the wiring conductor 100. Examples of the material constituting the adhesive layer 120 include a thermosetting resin such as a urea-based resin, a melamine-based resin, a phenol-based resin, an epoxy-based resin, a polyurethane-based resin, or a polyester-based resin; a thermoplastic resin such as a vinyl acetate-based resin, a polyvinyl alcohol-based resin, a vinyl chloride-based resin, a (meth)acrylic-based resin, or a polyethylene-based resin; and an elastomer such as a chloroprene-based rubber or a silicone-based rubber. These can be used alone or in combination of two or more. However, when the coil component 200 is connected to a soldered circuit board or the like by reflow, a thermosetting resin such as a urea-based resin, a melamine-based resin, a phenol-based resin, an epoxy-based resin, a polyurethane-based resin, or a polyester-based resin is preferable as the material constituting the adhesive layer 120.

The thickness of the adhesive layer 120 is not particularly limited, and may be 1 μm or more, 3 μm or more, 10 μm or more, or 20 μm or more.

The thickness of the adhesive layer 120 may be 1000 μm or less, 500 μm or less, 300 μm or less, 100 μm or less, 80 μm or less, or 50 μm or less.

### <<Method for Manufacturing Coil Component>>

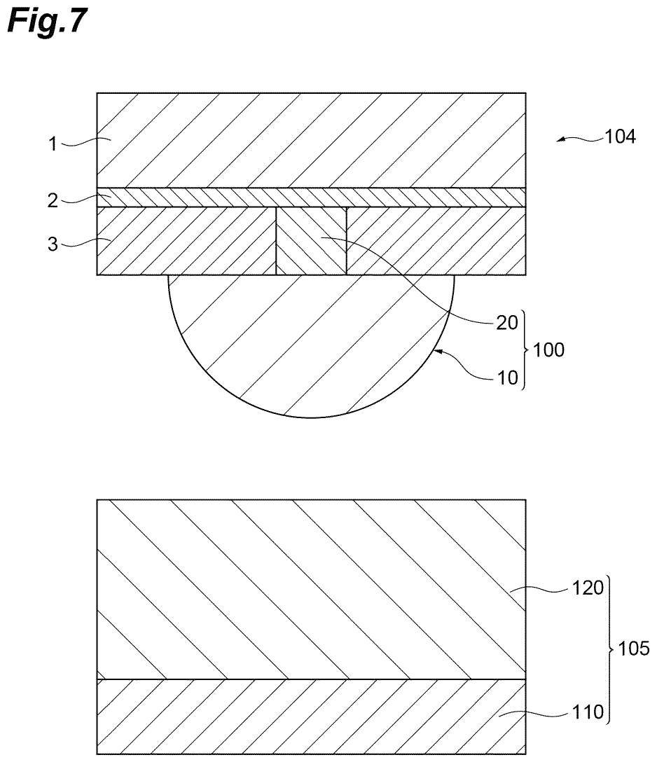

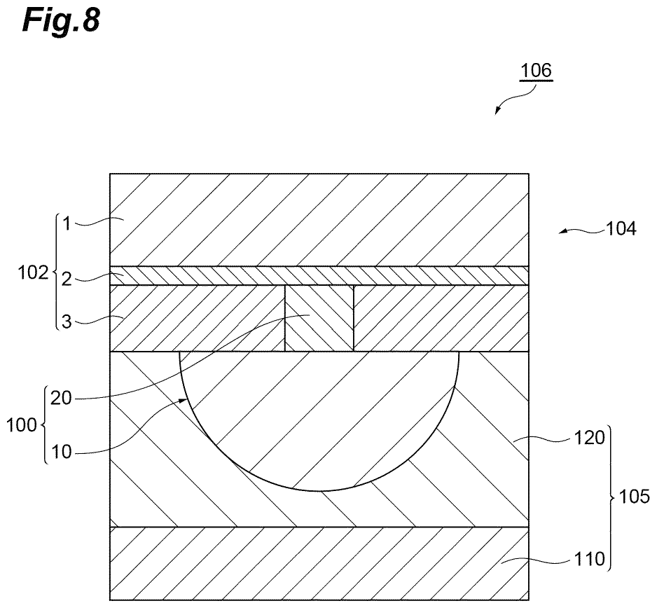

Next, a method for manufacturing the coil component 200 will be described with reference to FIGS. 7 and 8. FIG. 7 is a cross-sectional view illustrating a state before the fourth structure in FIG. 5 is fixed to the fifth structure, and FIG. 8 is a cross-sectional view illustrating a state after the fourth structure in FIG. 5 is fixed to the fifth structure.

First, the fifth structure 105 formed by laminating the adhesive layer 120 on the base material 110 is prepared, and as illustrated in FIG. 7, the fourth structure 104 is disposed with respect to the fifth structure 105 such that the wiring conductor 100 faces the fifth structure 105 side.

Next, the fourth structure 104 and the fifth structure 105 are stacked together to form a laminate, and the laminate is heated and pressurized to bond the fourth structure 104 and the fifth structure 105 together to obtain a sixth structure 106.

At this time, it is preferable to embed the main body portion 10 of the wiring conductor 100 in the adhesive layer 120. In this case, even if temperature changes during use of the coil component 200, the wiring conductor 100 is less likely to be detached from the adhesive layer 120.

Finally, the second structure 102 is peeled off from the sixth structure 106.

The coil component 200 is obtained as described above.

The present disclosure is not limited to the above embodiments. For example, in the above embodiments, the wiring conductor 100 has the protrusion 20, but the wiring conductor of the present disclosure may not have the protrusion 20.

In addition, in the above embodiments, the second surface 12 of the wiring conductor 100 faces the base material 110 side (see FIG. 7) in the coil component 200, but the first surface 11 may face the base material 110 side instead of the second surface 12. The coil component having the first surface 11 facing the base material 110 side can be obtained, for example, by providing a magnetic body on the substrate 1 on the side opposite to the wiring conductor 100 when the substrate 1 is formed of a heat-resistant film such as a polyimide resin film in the fourth structure 104.

In addition, the coil component 200 includes the adhesive layer 120, but may not include the adhesive layer 120 when the base material 110 can fix the wiring conductor 100.

### EXAMPLES

Hereinafter, the contents of the present disclosure will be specifically described with reference to examples, but the present disclosure is not limited to the following examples.

### Example 1

First, a PET film (thickness: 100 μm) was prepared as a substrate, and then a Pt dispersion liquid obtained by dispersing Pt particles was applied onto the substrate and dried to form a conductive layer (thickness: 60 nm) made of Pt as an electroless plating catalyst, thereby obtaining a first structure.

Next, a curable resin composition was prepared, applied to a surface of the conductive layer, and dried to form a coating film (thickness: 1 μm). Subsequently, a coil-shaped groove pattern was formed on the coating film by an imprinting method. Specifically, a mold having a coil-shaped projection was pushed, the curable resin composition was cured by UV irradiation, and then the mold was pulled out from the coating film to obtain a second structure including a resin layer having the groove pattern. At this time, the shape of the groove pattern was a coiled shape. The width of the groove was 2 μm, an interval between adjacent grooves was 58 μm, and the number of turns of the coil-shaped groove pattern was 16. In addition, the groove pattern was formed so that the conductive layer was exposed.

Next, the second structure was immersed in an electroless plating solution containing copper at 50° C. for 0.25 hours, and a protrusion was formed in the groove pattern on the exposed conductive layer by electroless plating to obtain a third structure.

Next, the third structure was immersed in an electrolytic plating solution composed of a sulfuric acid bath, electrolytic plating was performed at 25° C. for 1 hour under the condition of a current density of 5 A, metal plating was grown on the protrusion so as to have a height of 18 μm to form a main body portion, thereby forming a coil-shaped wiring conductor, and a through hole having a diameter of 0.5 mm was formed inside the coil-shaped wiring conductor, thereby obtaining a fourth structure.

On the other hand, a double-sided adhesive tape (manufactured by TESA TAPE CO., LTD., product name: TESA (registered trademark) 8851) having a thickness of 30 μm was formed as an adhesive layer on a magnetic sheet (manufactured by TDK Corporation, product name: IFQ-06H) having a thickness of 65 μm as a base material, and a through hole having a diameter of 0.5 mm was formed at the center to prepare a fifth structure.

Next, the fourth structure was disposed with respect to the fifth structure such that the wiring conductor faced the fifth structure side.

Next, the fourth structure and the fifth structure were stacked together to form a laminate. At this time, alignment was performed such that the through hole of the fifth structure and the through hole inside the coil-shaped wiring conductor of the fourth structure overlap with each other. Then, the laminate was placed in an autoclave and pressurized at a pressure of 0.5 MPa while being heated at 80° C. for 30 minutes to bond the fourth structure and the fifth structure together. At this time, the main body portion of the wiring conductor was embedded in the adhesive layer. Thereafter, the second structure was peeled off.

A coil component was obtained as described above. In the obtained coil component, as shown in Table 1, the diameter of the coil-shaped wiring conductor was 3.6 mm, the number of turns T of the coil-shaped wiring conductor (coil) was 16, and the interval between the adjacent wiring conductors (distance between the adjacent wiring conductors) was 30 μm. In addition, the coil component was cut in the thickness direction by an ion milling method, the cross section was observed with a scanning electron microscope (SEM), the width W of the first surface and the height H of the main body portion were measured in each cross section of a plurality of wiring conductors, and the aspect ratio R1 was obtained. Then, the average values of the aspect ratio R1, the height H of the main body portion, and the width W of the first surface in all of the cross sections were obtained. The results are shown in Table 1.

### Examples 2 to 5 and Comparative Examples 1 and 2

Coil components were fabricated in the same manner as in Example 1 except that the average values of the aspect ratio R1, the height H of the main body portion, and the width W of the first surface, and the distance between the adjacent wiring conductors in all of the cross sections of the plurality of wiring conductors were set to the values shown in Table 1.

### Examples 6 to 11 and Comparative Examples 3 and 4

Coil components were fabricated in the same manner as in Example 1 except that the average values of the aspect ratio R1, the height H of the main body portion, and the width W of the first surface, and the distance between the adjacent wiring conductors in all of the cross sections of the plurality of wiring conductors were set to the values shown in Table 2.

### Examples 12 to 17 and Comparative Examples 5 and 6

Coil components were fabricated in the same manner as in Example 1 except that the average values of the aspect ratio R1, the height H of the main body portion, and the width W of the first surface, and the distance between the adjacent wiring conductors in all of the cross sections of the plurality of wiring conductors were set to the values shown in Table 3.

For the coil-shaped wiring conductors of the coil components obtained in Examples 1 to 17 and Comparative Examples 1 to 6, AC resistance (ACR1) at a high frequency (frequency 13.56 MHz), AC resistance (ACR2) at a frequency of 100 kHz, and DC resistance (DCR) were measured. The results are shown in Tables 1 to 3. In addition, the value of ACR1−DCR was calculated from the results of the AC resistance (ACR1) and the DC resistance (DCR). The results are shown in Tables 1 to 3.

TABLE 1

| | | | | Distance | | | | | | |
|---|---|---|---|---|---|---|---|---|---|---|
| | | Height H of | Width W | between | | Diameter of | | | | Resistance |
| | Aspect | main body | of first | adjacent | Number of | coil-shaped | ACR1 | ACR2 | | deterioration |
| | ratio | portion | surface | wiring | turns T | wiring | (13.56 | (100 | | (ACR1- |
| | R1 | (average) | (average) | conductors | of coil | conductor | MHz) | kHz) | DCR | DCR) |
| | (average) | μm | μm | μm | μm | mm | Ω | Ω | Ω | Ω |
| Comparative | 0.3 | 9 | 30 | 30 | 16 | 3.6 | 11.73 | 11.67 | 11.67 | 0.06 |
| example 1 | | | | | | | | | | |
| Example 1 | 0.6 | 18 | 30 | 30 | 16 | 3.6 | 4.69 | 4.53 | 5.09 | −0.40 |
| Example 2 | 0.8 | 24 | 30 | 30 | 16 | 3.6 | 3.62 | 3.39 | 3.39 | 0.23 |
| Example 3 | 1 | 30 | 30 | 30 | 16 | 3.6 | 3.01 | 2.72 | 2.83 | 0.18 |
| Example 4 | 1.2 | 36 | 30 | 30 | 16 | 3.6 | 2.62 | 2.26 | 2.26 | 0.36 |
| Example 5 | 1.4 | 42 | 30 | 30 | 16 | 3.6 | 2.37 | 1.94 | 1.98 | 0.39 |
| Comparative | 1.6 | 48 | 30 | 30 | 16 | 3.6 | 2.21 | 1.70 | 1.70 | 0.52 |
| example 2 | | | | | | | | | | |

TABLE 2

| | | | | Distance | | | | | | |
|---|---|---|---|---|---|---|---|---|---|---|
| | | Height H of | Width W | between | | Diameter of | | | | Resistance |
| | Aspect | main body | of first | adjacent | Number of | coil-shaped | ACR1 | ACR2 | | deterioration |
| | ratio | portion | surface | wiring | turns T | wiring | (13.56 | (100 | | (ACR1- |
| | R1 | (average) | (average) | conductors | of coil | conductor | MHz) | kHz) | DCR | DCR) |
| | (average) | μm | μm | μm | μm | mm | Ω | Ω | Ω | Ω |
| Comparative | 0.3 | 12 | 40 | 20 | 16 | 3.6 | 6.39 | 6.19 | 6.19 | 0.20 |
| example 3 | | | | | | | | | | |
| Example 6 | 0.4 | 16 | 40 | 20 | 16 | 3.6 | 3.84 | 3.60 | 3.60 | 0.24 |
| Example 7 | 0.6 | 24 | 40 | 20 | 16 | 3.6 | 2.75 | 2.40 | 2.70 | 0.05 |
| Example 8 | 0.8 | 32 | 40 | 20 | 16 | 3.6 | 2.27 | 1.80 | 1.80 | 0.47 |
| Example 9 | 1 | 40 | 40 | 20 | 16 | 3.6 | 2.03 | 1.44 | 1.50 | 0.53 |
| Example 10 | 1.2 | 48 | 40 | 20 | 16 | 3.6 | 1.91 | 1.20 | 1.20 | 0.71 |
| Example 11 | 1.4 | 56 | 40 | 20 | 16 | 3.6 | 1.87 | 1.03 | 1.05 | 0.82 |
| Comparative | 1.6 | 64 | 40 | 20 | 16 | 3.6 | 1.88 | 0.90 | 0.90 | 0.98 |
| example 4 | | | | | | | | | | |

TABLE 3

| | | | | Distance | | | | | | |
|---|---|---|---|---|---|---|---|---|---|---|
| | | Height H of | Width W | between | | Diameter of | | | | Resistance |
| | Aspect | main body | of first | adjacent | Number of | coil-shaped | ACR1 | ACR2 | | deterioration |
| | ratio | portion | surface | wiring | turns T of | wiring | (13.56 | (100 | | (ACR1- |
| | R1 | (average) | (average) | conductors | coil | conductor | MHz) | kHz) | DCR | DCR) |
| | (average) | μm | μm | μm | μm | mm | Ω | Ω | Ω | Ω |
| Comparative | 0.3 | 15 | 50 | 10 | 16 | 3.6 | 3.77 | 3.65 | 3.65 | 0.12 |
| example 5 | | | | | | | | | | |
| Example 12 | 0.4 | 20 | 50 | 10 | 16 | 3.6 | 2.58 | 2.17 | 2.17 | 0.41 |
| Example 13 | 0.6 | 30 | 50 | 10 | 16 | 3.6 | 2.03 | 1.44 | 1.62 | 0.40 |
| Example 14 | 0.8 | 40 | 50 | 10 | 16 | 3.6 | 1.84 | 1.08 | 1.08 | 0.75 |
| Example 15 | 1 | 50 | 50 | 10 | 16 | 3.6 | 1.80 | 0.87 | 0.90 | 0.89 |
| Example 16 | 1.2 | 60 | 50 | 10 | 16 | 3.6 | 1.83 | 0.72 | 0.72 | 1.11 |
| Example 17 | 1.4 | 70 | 50 | 10 | 16 | 3.6 | 1.90 | 0.62 | 0.63 | 1.27 |
| Comparative | 1.6 | 80 | 50 | 10 | 16 | 3.6 | 1.98 | 0.54 | 0.54 | 1.44 |
| example 6 | | | | | | | | | | |

From the results shown in Table 1, it was found that the resistance (ACR1) due to the high frequency was sufficiently reduced in the wiring conductors of the coil components of Examples 1 to 5 as compared with the wiring conductor of the coil component of Comparative Example 1. In addition, it was found that the resistance deterioration due to the high frequency was sufficiently reduced in the wiring conductors of the coil components of Examples 1 to 5 as compared with the wiring conductor of the coil component of Comparative Example 2.

In addition, from the results shown in Table 2, it was found that the resistance (ACR1) due to the high frequency was sufficiently reduced in the wiring conductors of the coil components of Examples 6 to 11 as compared with the wiring conductor of the coil component of Comparative Example 3. In addition, it was found that the resistance deterioration due to the high frequency was sufficiently reduced in the wiring conductors of the coil components of Examples 6 to 11 as compared with the wiring conductor of the coil component of Comparative Example 4.

Furthermore, from the results shown in Table 3, it was found that the resistance (ACR1) due to the high frequency was sufficiently reduced in the wiring conductors of the coil components of Examples 12 to 17 as compared with the wiring conductor of the coil component of Comparative Example 5. In addition, it was found that the resistance deterioration due to the high frequency was sufficiently reduced in the wiring conductors of the coil components of Examples 12 to 17 as compared with the wiring conductor of the coil component of Comparative Example 6.

From the above, according to the wiring conductor of the present disclosure, it has been confirmed that even when a high-frequency current flows, the resistance can be reduced as compared with a wiring conductor having an aspect ratio of less than 0.4. In addition, according to the wiring conductor of the present disclosure, it has been confirmed that even when the high-frequency current flows, the resistance deterioration can be reduced as compared with a wiring conductor having an aspect ratio exceeding 1.4.

Note that the outline of the present disclosure is as follows.
[1] A wiring conductor including a main body portion, in which the main body portion includes a first surface and a second surface connecting both edges of the first surface, the second surface is a curved surface, and an aspect ratio that is a ratio of a height of the main body portion from the first surface to a width of the first surface is 0.4 to 1.4.
[2] The wiring conductor according to [1], in which the width of the first surface is 25 μm or more.
[3] The wiring conductor according to [2], in which the width of the first surface is 25 to 60 μm.
[4] The wiring conductor according to any of [1] to [3], further including a protrusion provided on the first surface.
[5] The wiring conductor according to [4], in which the protrusion and the main body portion include at least one selected from the group consisting of Ag, Au, Zn, Cr, Ni, Sn, Cu, a Cu—Co alloy, a Cu—Fe alloy, a Cu—Pd alloy, a Cu—Sn alloy, a Cu—Zn alloy, a Cu—Fe—Ni alloy, a Cu—Zn—Cd alloy, and a Cu—Zn—Ni alloy.
[6] The wiring conductor according to [4], in which materials constituting the protrusion and the main body portion are different from each other.
[7] The wiring conductor according to any of [1] to [6], in which the wiring conductor is a coiled shape.
[8] A coil component including: the wiring conductor according to [7]; and a base material provided at a position facing the wiring conductor.
[9] The coil component according to [8], in which the base material is a magnetic body.

The coil component according to [8] or [9], further including an adhesive layer configured to fix the wiring conductor to the base material.

### REFERENCE SIGNS LIST

10 Main body portion
11 First surface
12 Second surface
20 Protrusion
100 Wiring conductor
110 Base material
120 Adhesive layer
200 Coil component
W Width of first surface
H Height of main body portion.

1. A wiring conductor comprising a main body portion, wherein
the main body portion includes a first surface and a second surface connecting both edges of the first surface,
the second surface is a curved surface, and
an aspect ratio that is a ratio of a height of the main body portion from the first surface to a width of the first surface is 0.4 to 1.4.

2. The wiring conductor according to claim 1, wherein the width of the first surface is 25 μm or more.

3. The wiring conductor according to claim 2, wherein the width of the first surface is 25 to 60 μm.

4. The wiring conductor according to claim 1, further comprising a protrusion provided on the first surface.

5. The wiring conductor according to claim 4, wherein the protrusion and the main body portion include at least one selected from the group consisting of Ag, Au, Zn, Cr, Ni, Sn, Cu, a Cu—Co alloy, a Cu—Fe alloy, a Cu—Pd alloy, a Cu—Sn alloy, a Cu—Zn alloy, a Cu—Fe—Ni alloy, a Cu—Zn—Cd alloy, and a Cu—Zn—Ni alloy.

6. The wiring conductor according to claim 4, wherein materials constituting the protrusion and the main body portion are different from each other.

7. The wiring conductor according to claim 1, wherein the wiring conductor has a coiled shape.

8. A coil component comprising:
the wiring conductor according to claim 7; and
a base material provided at a position facing the wiring conductor.

9. The coil component according to claim 8, wherein the base material is a magnetic body.

10. The coil component according to claim 8, further comprising an adhesive layer configured to fix the wiring conductor to the base material.
